(19) United States
(12) Patent Application Publication
(10) Pub. No.: US 2025/0018999 A1
(43) Pub. Date: Jan. 16, 2025

(54) STEERING ASSIST SYSTEM FOR ADJUSTABLE STEERING FORCE

(71) Applicant: Independent Driving Systems, Inc., Houston, TX (US)

(72) Inventor: Julio Rodrigo SAEZ ARDILES, Houston, TX (US)

(21) Appl. No.: 18/769,065

(22) Filed: Jul. 10, 2024

Related U.S. Application Data
(60) Provisional application No. 63/512,703, filed on Jul. 10, 2023.

(51) Int. Cl. B62D 5/04; B60R 16/03

(52) U.S. Cl. CPC B62D 5/0463; B60R 16/03; B62D 5/0409; B62D 5/0484; B62D 5/049

(57) ABSTRACT

A steering assist system for a vehicle has a steering column connected to a steering wheel of the vehicle, an assist motor connected to the steering column so as to provide torque to the steering column for allowing a driver to rotate the steering column, an electronic power steering system electrically connected to the assist motor so as to provide a current to drive said assist motor, and a controller electrically connected to the electronic power steering system. The steering column is operatively connected to the wheels of the vehicle. The controller transmits a signal to the electronic power steering system to cause electronic power steering system to transmit the current of the desired level to set the assist motor.

### CROSS-REFERENCE TO RELATED APPLICATIONS

The present application claims priority from U.S. Provisional Patent Application No. 63/512,703, filed on Jul. 10, 2023.

### BACKGROUND OF THE INVENTION

The present invention relates to power steering systems. More particularly, the present invention relates to steering assist systems in which the torque applied to the steering column is adjustable. More particularly, the present invention relates to steering assist systems for use in vehicles for the handicapped and disabled.

Difficulties are often encountered when a disabled person without full use of at least one leg/foot and two hands wishes to drive the automobile. Typically, a foot or two feet will control brake and gas. A first hand continuously remains on the steering wheel, and a second hand is available to control other important functions that are necessary during the driving process (e.g., turn signals, dimmers, wipers, etc.). Although many important vehicle functions have been relocated to a vehicle steering wheel for easy access by a non-disabled driver, this does not serve the needs of disabled requiring an ergonomic prosthetic steering interface integrated with vehicle controls.

There have been some inventive efforts directed at alleviating the problems associated with controlling vehicle functions and conjunctions with a prosthetic steering device. For example, Access Unlimited in the United States manufactures and distributes the product which provides an array of switches located in board of the axis of a prosthetic steering device on a panel which is fixed to a steering wheel.

A major problem affecting those that are disabled or handicapped is the force required for the rotation of the steering wheel for the steering of the vehicle. Power steering systems are widely available in most vehicles currently produced. However, even with such power steering systems, the force required to rotate the steering wheel by the disabled or handicapped is too great in order to accomplish the desired task. As such, a need has developed so as to provide a system whereby the torque provided by the OEM-provided power steering system can be enhanced so as to require reduced effort by the disabled or handicapped.

Those that are handicapped or disabled have various levels of disability. Under certain circumstances, many have enough arm strength to rotate the steering wheel with a particular force. However, other disabled or handicapped persons could properly rotate the steering wheel if less force was required. As such, a need has developed so as to allow the operator of vehicle to properly adjust the amount of steering force required in order to meet the abilities of the particular driver.

In other circumstances, vehicles that have been built for the handicapped and disabled allow such a person to operate such vehicles. However, under other circumstances, non-handicapped persons will also wish to operate such vehicles. If the force required to rotate the steering wheel is too little, a conventional non-handicapped driver will have difficult controlling the vehicle. As such, need has developed so as to allow the steering system of the vehicle to be adjusted between handicapped use and non-handicapped use.

Under certain circumstances, the electronic power steering system of the vehicle and the central area network (CAN) of the vehicle will operate in conjunction so as to shut down the power steering system if a vehicle failure event occurs. When a failure event occurs, the electronic power steering system will shut down the assist motor such that only manual force can be utilized so as to control steering. This manual force is entirely too great for use by the handicapped or disabled. As such, when the electronic power steering system senses a failure event, those disabled or handicapped will be unable to properly manipulate the vehicle under emergency circumstances, such as moving the vehicle to the side of the road or otherwise parking the vehicle. Under many circumstances, the torque sensor can cause the failure event. Torque sensors are notorious for providing a signal to the electronic power steering system of a failure event. This can occur on a momentary basis, such as interference from a CB radio. This failure event is noted by the electronic power steering system so as to shut down the assist motor, even though the interruption and failure event is only momentary. As such, a need has developed so as to allow the torque sensor and the electronic power steering system to be set back to operable easily and quickly.

According to statistics, since October 2022, approximately 10% of the vehicles sold in the United States were hybrid or electric. This is expected to exceed 30% by 2030. In turn, it is expected that by 2024, Autonomous Vehicles (AV) will begin to circulate massively in the United States. This is important because, since 2021, vehicles come with Electric Power Assisted Steering systems that allow vehicles to perform automatic steering control maneuvers, such as “Lane Keep” and “Parking Assist”. Because of this, the vast majority of vehicles now have steering systems with digital torque sensors. This new generation of digital torque sensors are not compatible with traditional analog stress reduction methods, where the solution was the use of analog operational amplifiers or simple transistor arrays.

In the past, various patents and publications have issued with respect to steering wheel assist systems. For example, U.S. Pat. No. 7,621,365, issued on Nov. 24, 2009 to T. F. Egan, describes a technique for controlling vehicle functions. The apparatus has a support member configured to attach to a steering wheel of a vehicle. A switch assembly is fixedly attached to the support member for electrically controlling functions of the vehicle. A prosthetic steering device is rotatably attached to the support member for manually controlling steering of the vehicle.

U.S. Pat. No. 8,594,892, issued on Nov. 26, 2013 to Fujimoto et al., shows an electric power steering apparatus for a vehicle. This apparatus has a steering angle estimation section that calculates a front-wheel-side estimated steering angle and a rear-wheel-side estimated steering angle through the use of wheel speeds of respective wheels. It then averages the steering angles to thereby obtain an accurate estimated steering angle. It calculates an estimated steering angle difference between the steering angles. An axial course estimation section calculates a base axial force through the use of the estimate aided steering angle and a vehicle speed and calculates a correlation axial force which applies an axial force difference to the base axial force in accordance with a turning or returning operation by the driver. The axial force estimated section adds the base axial force and the correction axial force together to calculate an accurate estimated axial force. An assist computation section compares a target steering torque, which changes with the vehicle speed, and an accurate estimative axial force, and subtracts the target steering torque from the estimated axial force, to calculate an assist torque.

U.S. Pat. No. 9,227,653, issued on Jan. 5, 2016 to Kita et al., provides an electric power steering system that includes a first rack-and-pinion mechanism that converts rotation of a pinion shaft due to a steering operation into reciprocating motion of a rack shaft. A steering force assist devices applies a motor torque as an assist force by using a second rack-and-pinion mechanism. An ECU controls an operation of the steering force assist device. The ECU computes a motor neutral point by subtracting a conversion value from a motor angle detection value. The conversion value is computed based on a steering angle detection value by referring to a conversion map that is set taking into account the steering gear ratio corresponding to the steering angle.

U.S. Pat. No. 9,598,101, issued Mar. 21, 2019 to Kimura et al., provides a steering assist device for a vehicle that includes a transmission device configured to transmit a force and a displacement relating to steering between a steering wheel and steered wheels. A power steering device is configured to apply and assist torque to the transmission device. The power steering apparatus also includes a control device. When assuming the steering wheel, the transmission device, the power steering device, and the steered wheels allows the control device to be configured to calculate a product of the steering angle velocity and a steering torque. A change in the rate of an energy of the steering system allows the assist torque to be controlled.

U.S. Pat. No. 10,513,287, issued on Dec. 24, 2019 to T. Tsubaki, discloses an electric power steering apparatus for autonomous driving of a vehicle. The ECU of the electric power steering apparatus includes a steering angle control section, an assist control section, and a switching determination/gradual change gain generating section by which a steering angle control output and assist control output are multiplied. It multiplies a gradual change gain to make a switching determination between a steering angle control mode and an assist control mode.

U.S. Patent Application No. 2005/0224272, published on Oct. 13, 2005 to F. Crawford, shows an ergonomic vehicle control system that includes a control panel, a plurality of hydrostatic motors, a speed gear and a plurality of hydraulic lines for connecting the speed gear to the plurality of hydrostatic motors. The plurality of hydrostatic motors are operably connected to a plurality of vehicle wheels. The control system further includes a steering box and a hydrostatic pump operably connected thereto. A first controller is connected to the control panel, the steering box and the hydrostatic pump, respectively. The control system further includes a second controller connected to the control panel and the speed gear, respectively. The control panel further includes an elongated control lever electrically coupled to the first and second controllers so that an operator can effectively control movement of the vehicle.

U.S. Patent Application No. 2005/0275205, published on Dec. 15, 2015 to B. Ahnafield, provides a small diameter steering wheel apparatus for use by physically-challenged drivers. This steering apparatus has a steering wheel having a diameter slightly smaller than the diameter of a standard steering wheel and a position and coding mechanism coupled to the steering wheel. The position and coding mechanism is operable to generate a position signal in relation to the amount of rotation of the steering wheel. This position signal is fed to a processor that is operable to generate a steering command in relation to the position signal. The command directs a steering mechanism to rotate the steering shaft in response thereto. The position and coding mechanism includes a steering gear rotatable with the steering wheel and at least three driven gears and associated position sensors meshed with the steering gear so as to provide triple redundancy to the position signal used to generate the steering command. The steering apparatus further comprises a sensitivity mechanism that is operable to produce an adjustment resistance to rotation of the steering wheel.

U.S. Patent Application No. 2015/0025743, published on Jan. 22, 2015 to Tamura et al., teaches a vehicle steering device that includes a steering torque detection unit that detects a steering torque. The vehicle steering device controls an electric current value which is applied to an electric motor and applies an assist torque to a steering system based on the steering torque.

European Patent No. 0 853 557, published on Feb. 26, 2003 to R. Sebazo, describes a control system that has a steering wheel, a pivotal mechanism, a sleeve, and a force translating mechanism. The pivotal mechanism has first and second ends with an intermediate portion therebetween. Each end has connectors with the first end connected to the steering wheel and an intermediate portion connected to the steering column. The pivotal mechanism is arranged so as to draw the second end in the opposite direction of the first end when a substantially axial force is exerted on the steering wheel. The sleeve is located on the steering column of the vehicle and has a bore dimension to allow the passage of the steering shaft of the vehicle.

European Patent No. 1 990 257, published on Apr. 7, 2010 to A. Nishimura, shows an electric power steering apparatus applied to a steering system that transmits a steering operation of a driver to a steerable wheel. This apparatus has a steering force assist device provided with a motor. The steering force assist device applies an assist force for assisting the steering operation to the steering system by rotating a steering shaft that couples a steering wheel operated by the driver to the steerable wheel when using the motor. A controller controls actuation of the steering force assist device by feeding a driving power to the motor. A speed reduction mechanism is provided with first and second gears mashed with each other. The motor is drivingly coupled to the steering shaft via the speed reducing mechanism.

It is an object of the present invention to provide a steering assist system that provides a user with the ability to switch between handicapped drivers and non-handicapped drivers.

It is another object the present invention to provide a steering assist system that allows the operator the ability to adapt for progressive disability.

It is another object of the present invention to provide a steering assist system that allows the user to retain steering assist in the event of a failure mode detected by the central area network of the vehicle.

It is another object of the present invention to provide a steering system that reduces steering effort.

It is another object of the present invention to provide a steering assist system that is easily installed onto conventional vehicles.

It is another object of the present invention to provide a steering assist system that monitors the state of the steering assist system.

It is another object of the present invention to provide a steering assist system that overrides failures of the steering assist.

It is still further object of the present invention to provide a steering assist system that allows an operator to set the desired amount of assist provided.

These and other objects and advantages of the present invention will become apparent from a reading of the attached specification and appended claims.

### SUMMARY OF THE INVENTION

The present invention is a steering assist system for a vehicle that comprises a steering column connected to a steering wheel of the vehicle, an assist motor connected to the steering column so as to provide torque to the steering column for allowing the driver to rotate the steering wheel, an electronic power steering system electrically connected to the assist motor so as to provide a current to drive the assist motor, and a controller electrically connected to the electronic power steering system. The steering column is operatively connected the wheels of the vehicle. The controller transmits a signal to the electronic power steering system to cause the electronic power steering system to transmit the current at a desired level to set the assist motor.

In the present invention, a signal from the controller causes the electronic power steering system to continue to supply current to the assist motor in a failure event. A torque sensor is cooperative with the steering column so as to sense a torque of the steering column. The failure event can be a loss of power to or from the torque sensor. The torque sensor is electrically connected to the controller so as to transmit torque information to the controller. A central area network is electrically connected to the electronic power steering system. This central area network monitors systems of the vehicle. The failure event can be an interruption of one of the systems of the vehicle.

A switch is positioned in proximity to an operator of the vehicle. The switch is electrically connected to the controller. The switch is operative to allow the user to change from a manual steering assist to an enhanced steering assist. The enhanced steering assist causes the electronic power steering system to transmit additional current to the assist motor to reduce torque required in the rotation of the steering wheel by the steering wheel. The normal steering assist is set by the original equipment manufacturer. The enhanced steering assist is 10 to 50% of the torque of the normal steering assist. The switch can be a pushbutton positioned adjacent to the steering wheel.

The controller is adapted to cause the assist motor to supply torque to the steering column for at least 180 seconds following the failure event. The controller is adjustable so as to vary a signal to the electronic power steering system in relation to a desired torque to be applied by the assist motor to steering column. An ignition system is connected to the controller and to the electronic power steering system. The electronic power steering system is adapted to switch off the ignition system during the failure event. The controller is a plug-and-play box connected to the electronic power steering system. The controller and the electronic power steering system are digital.

The controller can have a BLUETOOTH™ transmitter/receiver therein. The system further includes an application connected by BLUETOOTH™ to the BLUETOOTH™ transmitter/receiver. The application is adaptable to allow a user to remotely set the controller to fix a torque of the assist motor. A power supply is electrically connected to the electronic power steering system. The controller is adapted to restart the torque sensor after the failure event is sensed.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is a schematic showing the operation of the steering assist system of the present invention.

FIG. 2 is a graph showing the internal processing of the controller of the present invention.

### DETAILED DESCRIPTION OF THE INVENTION

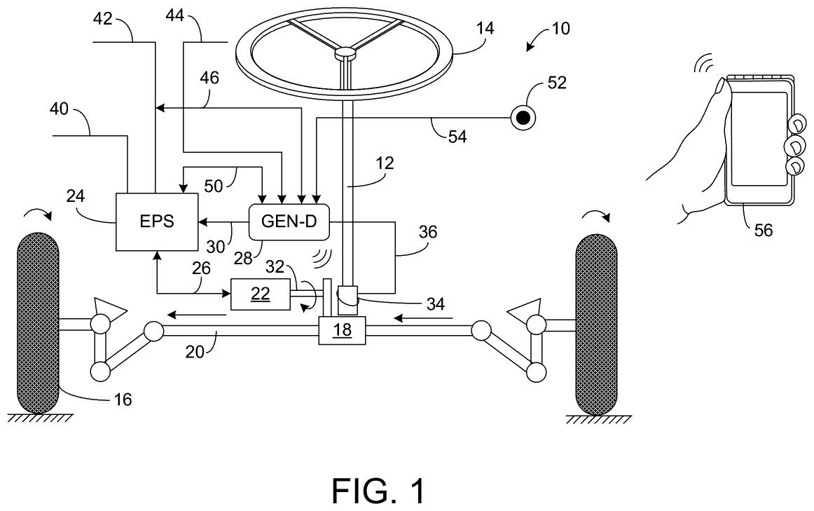

FIG. 1 shows the steering assist system 10 of the present invention. The steering assist system 10 is particularly configured to be utilized by handicapped or disabled persons, along with non-handicap and non-disabled persons. The steering assist system 10 includes a steering column 12 connected to a steering wheel 14 of the vehicle. The steering column 12 is operatively connected to the wheels 16 of the vehicle. In particular, the steering column 12 is connected to a pinion 18 operatively connected to the steering mechanism 20 of the vehicle. An assist motor 22 is connected to the steering column 12 so as to provide torque to the steering column 12 for allowing the driver to rotate the steering wheel 14 with reduced effort. An electric power steering system (EPS) 24 is electrically connected to the assist motor 22 by line 26 so as to provide a current to drive the assist motor 22. A controller 28 is electrically connected along line 30 to the electronic power steering system 24. The controller 28 transmits a signal along line 30 to the electronic power steering system 24 so as to cause the electronic power steering system 24 to transmit the current at a desired level along line 26 to the assist motor 22. The assist motor 22 operates on a shaft 32 so as to provide torque to the steering column 12.

A digital torque sensor 34 is applied over the steering column 12. Digital torque sensor 34 provides information along line 36 to the controller 28 as to the amount of torque applied to the steering column 12 by the assist motor 22 and/or by the operator of the vehicle.

The electronic power steering system 24 includes a power input 40 from a power source within the vehicle, such as a battery. A can bus 42 extends from the central area network of the vehicle to the electronic power steering system 24. An ignition system is connected along line 44 to the electronic power steering system 24. The can bus 42 is cooperative with the controller 28 along line 46. The can bus 42 is operative so as to sense a failure condition within the vehicle. This failure condition can be transmitted to the controller 28 along line 46. Similarly, information data from the controller 28 can be transmitted to the can bus 42 and ultimately to the electronic power steering system 24. The ignition line 44 extends to the controller 28. An ignition line 50 will extend from the controller 28 to the electronic power steering system 24. An LED/button 52 is connected by line 54 to the controller 28. Button 52 allows an operator of the vehicle to set the amount of torque applied by the assist motor 22 to the steering column 12. In particular, the LED/button 52 is a switch that allows the user to switch between the steering assist set by the original equipment manufacturer to an enhanced steering assist for use in those circumstances where a handicapped or disabled person is operating the vehicle.

The controller 28 can be equipped with a BLUETOOTH™ transmitter/receiver. A handheld phone 56 will have an application thereon that is communicative with the BLUETOOTH™ transmitter/receiver in the controller 28 so as to control operations of the assist motor 22. This can include an adjustment mechanism wherein, as the ability of the handicapped or disabled person diminishes, adjustments in torque can be made to the assist motor 22 through the controller 28 and the electronic power steering system 24.

As the steering wheel 14 rotates, the digital torque sensor 34 creates a digital data frame. This digital torque sensor 34 will ultimately send a “torque in” signal along line 36 to the controller 28. This is a numerical value proportional to the difference in torque between the steering wheel 14 and the pinion 18. This “torque in” along line 36 is captured by the controller 28. The controller 28 decrypts the information and performs a linear transformation on the information. A closed-loop discrete PID control is applied and a new encrypted digital frame is created that includes the resulting torque value and a “torque out” signal along line 30. This self-adjusts and adapts to the optimal range for the electronic power steering system 24. The electronic power steering system 24 controls current along line 26 to the assist motor 22 and corrects the position of the pinion 18 looking for a new position of the steering wheel 14.

During operation, the controller 28 permanently monitors the can bus signal 42, from where it continuously reads the vehicle speed, engine RPM, battery voltage and electronic power steering system status. It in the case of where the electronic power steering system 24 indicates that a failure has occurred and it has stopped assisting, the controller 28 activates the backup mode and tries to wake up the electronic power steering system 24, for which by way of a relay, it disconnects the ignition out signal along line 50 for 300 milliseconds and reconnects it again. This generates a reset of the electronic power steering system 24. During this time, the LED/button 52 will light up. An internal buzzer in the controller 28 will emit an audible alarm as long as the electronic power steering system 24 status indicated on the can bus 42 does not enter normal mode operation.

The LED/button 52 allows the user to change the operating mode. If the LED/button 52 is pressed one time, the reduced mode is activated. If the LED/button 52 is pressed two times, the original equipment manufacturers mode of steering assist is activated. If the LED/button 52 is pressed three times, the backup self-test mode is activated.

The present invention allows an application to be installed on a handheld device 56. As such, the user can make the basic settings of the controller 28 during its installation. The handheld device 56 can also monitor the “torque in” along line 36 and the “torque out” along line 30.

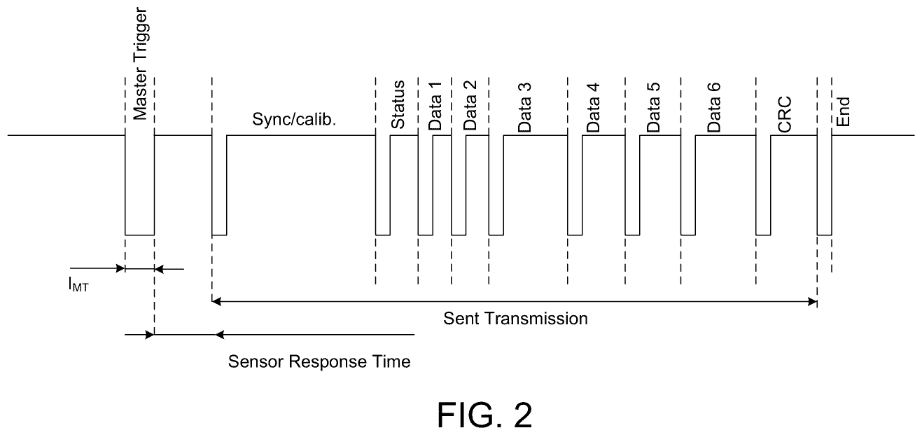

FIG. 2 illustrates the internal processes of the controller 58. The “torque in” signal 36 is processed as a continuous frame of bits that comply with the SENT protocol. The SENT protocol is a one-way, asynchronous voltage interface which requires three wires. These wires include a signal line (low state<0.5 V, high state>4.1 V), a supply voltage line (5 V) and a ground line. The SENT protocol uses pulse-width modulation to encode four bits per symbol.

The basic unit of time in the SENT protocol is called a “tick”. The tick can be between 3-90 milliseconds, at the sender's option. Each message is preceded by a calibration pulse with a high period of 56 ticks for framing and calibration of tick length. After the calibration pulse, each nibble is transmitted with a fixed-with low signal, followed by a variable-length high period. The low period is five or more ticks in length. The high period can vary for a total time between the falling edges of between 12 and 27 ticks.

For the SENT protocol, a sent message is 32 bits long and includes 24 bits of signal data that represent two measurement channels of three nibbles each (such as pressure and temperature), four bits for CRC error detection, and four bits of status/communication information. From this data package, according to each manufacturer, different data configurations and different ranges are obtained.

The foregoing disclosure and description of the invention is illustrative and explanatory thereof. Various changes in the details of the present invention can be made is the scope of the present claims without departing from the true spirit of the invention. The present invention should only be limited by the following claims and their legal equivalents.

1. A steering assist system for a vehicle comprising:
a steering column connected to a steering wheel of the vehicle, the steering column being operatively connected to wheels of the vehicle;
an assist motor connected to the steering column so as to provide torque to the steering column for allowing the driver to rotate the steering wheel;
an electronic power steering system electrically connected to said assist motor so as to provide a current to drive said assist motor; and
a controller electrically connected to said electronic power steering system, said controller for transmitting a signal to said electronic power steering system to cause the electronic power steering system to transmit the current at a desired level to set said assist motor so as to provide a desired amount of torque to the steering column.

2. The steering assist system of claim 1, wherein a signal from said controller causes the electronic power steering system to continue to supply the current to the assist motor in a failure event.

3. The steering assist system of claim 2, further comprising:
a torque sensor cooperative with said steering column so as to sense a torque of said steering column, the failure event being a loss of power to or from said torque sensor.

4. The steering assist system of claim 3, said torque sensor being electrically connected to said controller so as to transmit torque information to said controller.

5. The steering assist system of claim 2, further comprising:
a central area network electrically connected to said electronic power steering system, said central area network monitoring systems of the vehicle, the failure event being an interruption of one of the systems of the vehicle.

6. The steering assist system of claim 1, further comprising:
a switch positioned in proximity to an operator of the vehicle, said switch being electrically connected to said controller.

7. The steering assist system of claim 6, said switch operative to allow the user to change from a normal steering assist to an enhanced steering assist, the enhanced steering assist causing the electronic power steering system to transmit additional current to said assist motor to reduce torque required in the rotation of said steering column by the steering wheel.

8. The steering assist system of claim 7, the normal steering assist being set by the original equipment manufacturer, the enhanced steering assist being between 10% and 50% of the torque of the normal steering assist.

9. The steering assist system of claim 6, said switch being a pushbutton positioned adjacent to the steering wheel.

10. The steering assist system of claim 2, said controller adapted to cause said assist motor to supply torque to said steering column for at least 180 seconds following the failure event.

11. The steering assist system of claim 1, said controller being adjustable so as to vary a signal to the electronic powers steering system in relation to a desired torque to be applied by said assist motor to the steering column.

12. The steering assist system of claim 2, further comprising:
an ignition system connected to said controller and to said electronic power steering system, said electronic power steering system adapted to switch off said ignition system during the failure event.

13. The steering assist system of claim 1, said controller being a plug-and-play box connected to said electronic power steering system.

14. The steering assist system of claim 1, said controller and said electronic power steering system being digital.

15. The steering assist system of claim 1, said controller having a BLUETOOTH™ transmitter/receiver therein or thereon, the system further comprising:
an application connected by BLUETOOTH™ to the BLUETOOTH™ transmitter/receiver, said application adapted to allow a user to remotely set said controller and to fix a torque of said assist motor.

16. The steering assist system of claim 1, further comprising:
a power supply electrically connected to said electronic power steering system.

17. The steering assist system of claim 3, said controller adapted to restart said torque sensor after the failure event is sensed.
